(19) United States
(12) Patent Application Publication
(10) Pub. No.: US 2015/0277047 A1
(43) Pub. Date: Oct. 1, 2015

(54) METHODS OF FABRICATING PHOTOACTIVE SUBSTRATES SUITABLE FOR ELECTROMAGNETIC TRANSMISSION AND FILTERING APPLICATIONS

(71) Applicant: LIFE BIOSCIENCE, INC., Albuquerque, NM (US)

(72) Inventors: Jeb H. Flemming, Albuquerque, NM (US); Leo Kevin Dunn, Albuguergue, NM (US); Carrie F. Schmidt, Las Lunas, NM (US); Drichelle Lynn Pierce, Albuquerque, NM (US); Roger Cook, Albuquerque, NM (US); R. Blake Ridgeway, Albuquerque, NM (US); Colin T. Buckley, Albuquerque, NM (US); James Mathew Gouker, Albuquerque, NM (US)

(21) Appl. No.: 14/437,329

(22) PCT Filed: Sep. 11, 2013
(86) PCT No.: PCT/US2013/059305

§ 371 Date: Apr. 21, 2015

Related U.S. Application Data
(60) Provisional application No. 61/700,220, filed on Sep. 12, 2012.

(51) Int. Cl. G02B 6/136; G02B 6/12; G02B 6/132; G02B 1/12

(52) U.S. Cl. CPC G02B 6/136; G02B 1/12; G02B 6/12; G02B 6/132; G02B 2006/12104; G02B 2006/12061; G02B 2006/12109

(57) ABSTRACT

A method of fabrication and device made by preparing a photosensitive glass substrate comprising at least silica, lithium oxide, aluminum oxide, and cerium oxide, masking a design layout comprising one or more holes to form one or more electrical conduction paths on the photosensitive glass substrate, exposing at least one portion of the photosensitive glass substrate to an activating energy source, exposing the photosensitive glass substrate to a heating phase of at least ten minutes above its glass transition temperature, cooling the photosensitive glass substrate to transform at least part of the exposed glass to a crystalline material to form a glass-crystalline substrate and etching the glass-crystalline substrate with an etchant solution to form one or more angled channels that are then coated.

### TECHNICAL FIELD OF THE INVENTION

The present invention relates to a method to fabricate a glass structure and, in particular, a method to fabricate angled structures, mirrors and glass ceramic substrates for electromagnetic transmission and filtering.

### BACKGROUND ART

Photosensitive glass structures have been suggested for a number of micromachining and microfabrication processes such as inkjet printer heads, electrodes for high quality head phones, micro-lens arrays, positioning devices, and hollow microneedle arrays being developed for transdermal drug delivery and the withdrawal of body fluids for biomedical and other applications. Unfortunately, silicon microfabrication processes are long, difficult, and expensive. These microfabrication processes rely on expensive capital equipment; X-ray lithography and deep reactive ion etching machines which generally cost in excess of one million dollars each and require an ultra-clean, high-production silicon fabrication facility costing millions more.

Microprocessing has found it difficult to form angled structures are difficult, if not infeasible to create in most glass or silicon substrates. The present invention provides creates the capability to form such structures in both the vertical as well as horizontal plane for glass-ceramic substrates.

### DISCLOSURE OF THE INVENTION

The present invention includes a method to fabricate a substrate with one or more optical wave guides by preparing a photosensitive glass substrate and further coating with one or more metals.

A method of fabrication and device made by preparing a photosensitive glass substrate comprising at least silica, lithium oxide, aluminum oxide, and cerium oxide, masking a design layout comprising one or more holes to form one or more electrical conduction paths on the photosensitive glass substrate, exposing at least one portion of the photosensitive glass substrate to an activating energy source, exposing the photosensitive glass substrate to a heating phase of at least ten minutes above its glass transition temperature, cooling the photosensitive glass substrate to transform at least part of the exposed glass to a crystalline material to form a glass-crystalline substrate and etching the glass-crystalline substrate with an etchant solution to form one or more angled channels that are then coated.

### DESCRIPTION OF THE DRAWINGS

For a more complete understanding of the features and advantages of the present invention, reference is now made to the detailed description of the invention along with the accompanying figures and in which:

FIG. 1 is an image of the process of making the glass ceramic composition of the present invention.

FIGS. 2A-2C are images of TGV copper plug plating.

FIGS. 3A-3C are images of metal rails for more efficient RF electronics.

FIGS. 4A and 4B are images of the angled etched features of the present invention the angles can be at any angle from 0-45 degrees.

FIGS. 5A-5D are images of the spatially resolved optical elements and accompanying graphs.

FIGS. 6A-6C are images of the processing and metal adhesion to the glass substrate of the instant invention.

FIGS. 7A-7C are images of the blind vias.

FIGS. 8A and 8B are images of an integrated circuit and an image of TGVs.

FIG. 9 is an image of one embodiment of the present invention including an angled channel with a reflective coating such that the light may pass and be reflected in a different angle.

FIG. 10 is an image of one embodiment of the present invention including a angled channel with a reflective coating such that the light may pass and be reflected in a different angle.

FIG. 11 is an image of a filter wherein a first coated angled surface is positioned to reflect a specific wavelength while allowing other wavelengths to pass through.

FIG. 12A is an image of a quartz/chrome mask containing a variety of arcs with different angles and lengths and FIG. 12B is an image of reflection of light by angling it against a copper plated via to reflect light down an alternative path in the adjacent glass.

### DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not restrict the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

To address these needs, the present inventors developed a glass ceramic (APEX™ Glass ceramic) as a novel packaging material for semiconductors. APEX™ Glass ceramic is processed using first generation semiconductor equipment in a simple three-step process and the final material can be fashioned into either glass, ceramic, or contain regions of both glass and ceramic. The APEX™ Glass ceramic possesses several benefits over current materials, including: easily fabricated high density vias, demonstrated microfluidic capability, high Young's modulus for stiffer packages, halogen free manufacturing, and economical manufacturing.

Photoetchable glasses have several advantages for the fabrication of a wide variety of microsystems components. Microstructures have been produced relatively inexpensively with these glasses using conventional semiconductor processing equipment. In general, glasses have high temperature stability, good mechanical properties, are electrically insulating, and have better chemical resistance than plastics and many metals. To our knowledge, the only commercially available photoetchable glass is FOTURAN®, made by Schott Corporation and imported into the U.S. only by Invenios Inc. FOTURAN® comprises a lithium-aluminum-silicate glass containing traces of silver ions. When exposed to UV-light within the absorption band of cerium oxide the cerium oxide acts as sensitizers, absorbing a photon and loosing an electron that reduces neighboring silver oxide to form silver atoms, e.g.,

Ce³⁺+Ag⁺→Ce⁴⁺+Ag⁰

The silver atoms coalesce into silver nanoclusters during the baking process and induces nucleation sites for crystallization of the surrounding glass. If exposed to UV light through a mask, only the exposed regions of the glass will crystallize during subsequent heat treatment. This heat treatment must be performed at a temperature near the glass transformation temperature (e.g., greater than 465° C. in air for FOTURAN®). The crystalline phase is more soluble in etchants, such as hydrofluoric acid (HF), than the unexposed vitreous, amorphous regions. In particular, the crystalline regions of FOTURAN® are etched about 20 times faster than the amorphous regions in 10% HF, enabling microstructures with wall slopes ratios of about 20:1 when the exposed regions are removed. See T. R. Dietrich et al., “Fabrication technologies for microsystems utilizing photoetchable glass,” Microelectronic Engineering 30, 497 (1996), which is incorporated herein by reference.

Preferably, the shaped glass structure contains at least one of a micro-optic lens, a micro-optic micro-post, and a micro-channel or micro-ridge micro-optic waveguide. The micro-ridge, optical waveguide may be formed by etching away exposed glass to leave a glass micro-ridge such that light is guided by the micro-ridge. The micro-ridge may be formed with a layer of photosensitive glass overlying a layer of non-photosensitive glass of lower index of refraction than the photosensitive glass, to substantially prevent light being guided by the micro-ridge from leaving the bottom of the micro-ridge in at least one portion of the micro-ridge. In some embodiments, a surface-smoothing acid containing at least one of nitric acid to dissolve surface metallic silver and hydrochloric acid to dissolve surface cerium metal is used during or after the HF etch, whereby surface roughness of at least one micro-optic device in the shaped glass structure is reduced and whereby light transmission through surfaces of a micro-optic device is increased.

FOTURAN® is described in information supplied by Invenios (the sole source U.S. supplier for FOTURAN®) is composed of silicon oxide (SiO₂) of 75-85% by weight, lithium oxide (Li₂O) of 7-11% by weight, aluminum oxide (Al₂O₃) of 3-6% by weight, sodium oxide (Na₂O) of 1-2% by weight, 0.2-0.5% by weight antimonium trioxide (Sb₂O₃) or arsenic oxide (As₂O₃), silver oxide (Ag₂O) of 0.05-0.15% by weight, and cerium oxide (CeO₂) of 0.01-0.04% by weight.

As used herein the terms “APEX™ Glass ceramic”, “APEX glass” or simply “APEX” is used to denote one embodiment of the glass ceramic composition of the present invention.

The present invention includes a method for fabricating a glass ceramic structure for use in forming angled structures, mirrors and glass ceramic materials used in electromagnetic transmission and filtering applications. The present invention includes an angled structure created in the vertical or horizontal plane in a glass-ceramic substrate, such process employing the (a) exposure to excitation energy such that the exposure occurs at various angles by either altering the orientation of the substrate or of the energy source, (b) a bake step and (c) an etch step. Angle sizes can be either acute or obtuse.

Angled structures are difficult, if not infeasible to create in most glass or silicon substrates. The present invention has created the capability to create such structures in both the vertical as well as horizontal plane for glass-ceramic substrates.

The present invention includes a method for fabricating a glass ceramic mirror structures for use in electromagnetic transmission and filtering applications. The angled structure is coated with various metals, thin films or other reflective materials to modify the index of refraction (e.g., mirrors). In optics the refractive index (or index of refraction) of a substance (optical medium) is a number that describes how light, or any other radiation, propagates through that medium. It can also be used with wave phenomena other than light (e.g., sound, fluids). Apart from the transmitted light there is also a reflected part. The reflection angle is equal to the incidence angle, and the amount of light that is reflected is determined by the reflectivity of the surface.

The present invention allows for the development of negative refractive index structures, which can occur if permittivity and permeability have simultaneous negative values. The resulting negative refraction offers the possibility of creating superlenses and other exotic capability.

Application of metals, thin films or other reflective material on the surface of the Substrate of the present invention can be accomplished through wet chemistry, deposition techniques such as chemical vapor deposition, electroplating, e-beam deposition, lithography (e.g. additive and subtractive toners/photoresists) etc.

The present invention also provides wave guide which is a physical structure that guides electromagnetic waves in the optical spectrum. Common types of optical waveguides include optical fiber and rectangular waveguides. Optical waveguides are used as components in integrated optical circuits or as the transmission medium in local and long haul optical communication systems. Waveguides can also act as filters, allowing different energy frequencies or waveforms to be excluded or attenuated. The present invention forms an optical waveguide in glass-ceramic materials through coatings, and the control of the percentage of glass versus ceramic conversion that is accomplished through processing,

The present invention also provides absorptive filters. By modifying the glass ceramic compositions to include various inorganic or organic compounds. These compounds absorb some wavelengths of light while transmitting others.

The present invention provides dichroic filters (also called “reflective” or “thin film” or “interference” filters) can be made by coating the glass ceramic material with a series of optical coatings. Dichroic filters usually reflect the unwanted portion of the light and transmit the remainder. Dichroic filters use the principle of interference. Their layers form a sequential series of reflective cavities that resonate with the desired wavelengths. Other wavelengths destructively cancel or reflect as the peaks and troughs of the waves overlap.

The present invention may be used to make infrared filters, wherein the glass ceramic material can be processed to pass infrared (blocking other wavelengths) or to block infrared. The present invention may be used to make longpass filters which is an optical interference or colored glass filter that attenuates shorter wavelengths and transmits (passes) longer wavelengths over the active range of the target spectrum (ultraviolet, visible, or infrared). Longpass filters, which can have a very sharp slope (referred to as edge filters), are described by the cut-on wavelength at 50 percent of peak transmission. In fluorescence microscopy, longpass filters are frequently utilized in dichroic mirrors and barrier (emission) filters.

The present invention may be used to make bandpass filters that only transmit a certain wavelength band, and block others. The width of such a filter is expressed in the wavelength range it lets through and can be anything from much less than an angstrom to a few hundred nanometers. Such a filter can be made by combining a LP- and an SP filter.

The present invention may be used to make a shortpass (SP) filter which is an optical interference or coloured glass filter that attenuates longer wavelengths and transmits (passes) shorter wavelengths over the active range of the target spectrum (usually the ultraviolet and visible region). In fluorescence microscopy, shortpass filters are frequently employed in dichromatic mirrors and excitation filters.

The present invention may be used to make guided-mode resonance filters which are a relatively new class of filters introduced around 1990. These filters are normally filters in reflection that is they are notch filters in transmission. They consist in their most basic form of a substrate waveguide and a subwavelength grating or 2D hole arrays.

The present invention may be used to make other electromagnetic wave guides (e.g. microwave, acoustic, radio frequency, etc., given either the material properties of the glass, the ceramic or the hybrid glass-ceramic state.

The table below is a comparison of the technical specifications of the present invention (APEX) and silicon, FR-4 and LTCC.

| Metric | APEX ™ Glass | | Silicon | | FR-4 | | LTCC | |
|---|---|---|---|---|---|---|---|---|
| Thermal | 7.5-10 | ppm/K | 2.6 | ppm/K | 15 | ppm/K | 5.9-10 | ppm/K |
| expansion | | | | | | | | |
| Dielectric | 5.7 | | 11.7 | | 4.7 | | 5.9-7.9 | |
| constant | | | | | | | | |
| Tg | 450 | C. | N/A | | 110-200 | C. | N/A | |
| Young' s | 81 | GPa | 185 | GPa | 17 | GPa | 12-27 | GPa |
| Modulus | | | | | | | | |
| Manufacturing | Semiconductor | | Semiconductor | | CNC | | Screen | |
| method | based | | based | | drilled | | printing | |
| Minimum | <5 | um | <10 | um | 100 | um | 75-100 | um |
| through hole | | | | | | | | |
| size | | | | | | | | |
| Material | <100 | um | <100 | um | 40 | um | <100 | um |
| thickness | | | | | | | | |

| | | | | |
|---|---|---|---|---|
| Transparent | >90% 370-2300 nm | IR | No | No |
| Halogen Free? | Yes | Yes | No | Yes |

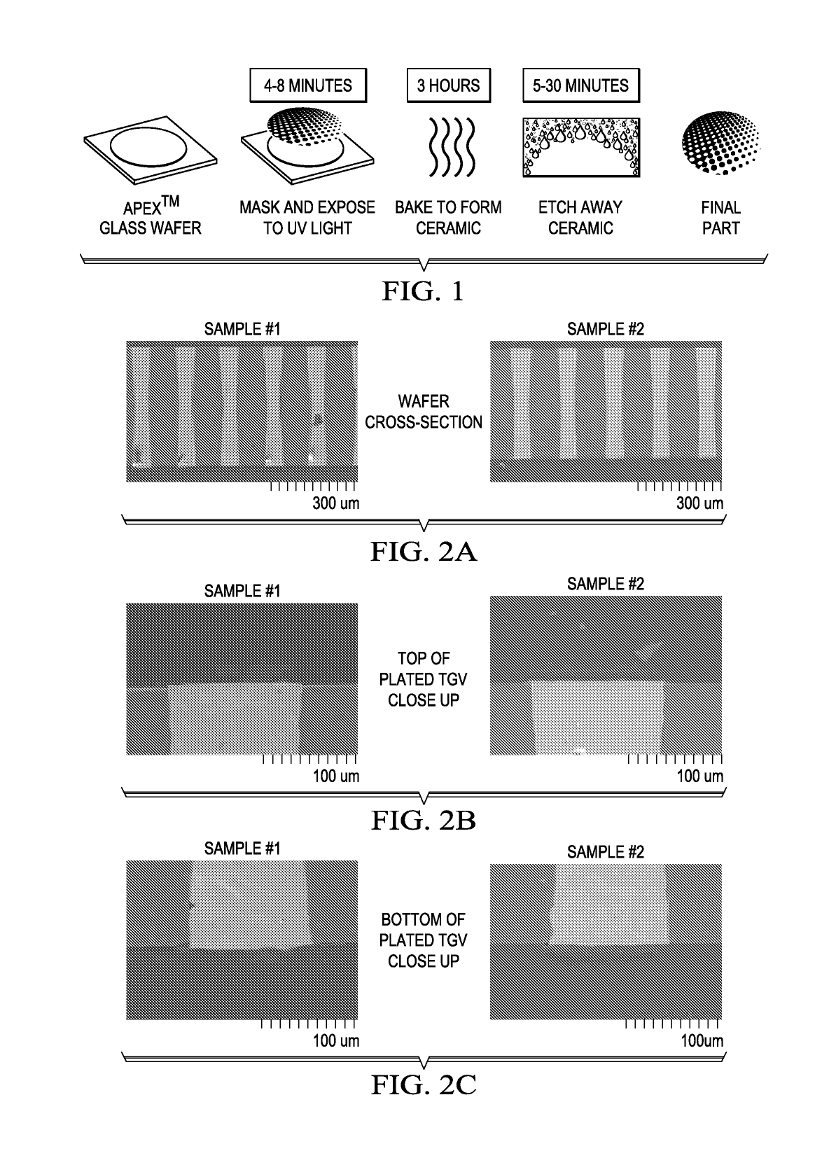

FIG. 1 is an image of the process of making the glass ceramic composition of the present invention. The composition wafer is placed on a substrate and specific areas masked off. The composition wafer is then UV exposed and the areas masked by the mask. The composition wafer is then baked and ceramic material formed in specific regions. The composition wafer is etched and the ceramic materials are removed to produce a final product. The present invention provides a 10 μm patterns on a 20 μm pitch•Array pattern: 40,000 TGVs per array and a Wafer had 100 arrays as such the total TGVs are about 4,000,000 with an exposure of 22 Joule/cm2 at 310 nm and an etch time of 4 minutes. The TGV diameter was about 9.61 microns+/−0.15 microns.•Produce over 100M TGVs in an 8″ wafer in under 30 minutes of processing time. FIG. 1 is a schematic of the processing steps for making structures in APEX™ Glass ceramic. FIG. 1 is an image of the different states of APEX™ Glass ceramic processing. FIG. 1 illustrates unprocessed, with imbedded microstructures processed (in this case an array of microwells), after secondary nucleation for full chip ceramicization, and fully formed ceramic part with imbedded microstructures (microwells). The present invention provides devices, parts and structures (entirely or in-part) that are either wholly glass, wholly ceramic, wholly precipitated nucleating agent (e.g., gold, silver, copper, etc), or contain regions of mixtures thereof. As such, the present invention provides a platform for microprocessors/semiconductor processing where a CPU chip may be mounted to an APEX™ GC device that contained ultra fine plated through holes for electrical conduction from CPU to the external components of the device, microfluidics for in-package cooling, optical wave guides for optoelectronic computing, and/or imbedded passive devices. Additionally, this approach may be used for other SiP, PoP, PiP, and SoC stack structures.

The present invention may be used to make a composition having a significantly lower capital costs; faster processing times; provides no debris sputtering; provide highly anisotropic profiles; provide no localized heat shock from fs lasers; and be a Micro-fracture free products. The composition of the present invention have been measured to maintain their native Young's modulus; native glass' Young's Modulus of 81 GPa; and have a 75 μm diameter TGV interposer array's Young's Modulus of 80 GPa. The present invention enables manufactures to produce unrivaled glass products with extremely narrow pitches while sP11 maintaining structural integrity.

FIGS. 2A-2C are images of TGV copper plug plating. The plating is accomplished using a bottom-up approach and a good metal filling approach for TGVs with >5:1 aspect ratios. FIG. 2A is a cross section of the image. FIG. 2B is a top view of the plated TGV. FIG. 2C is a bottom view of the plated TGV.

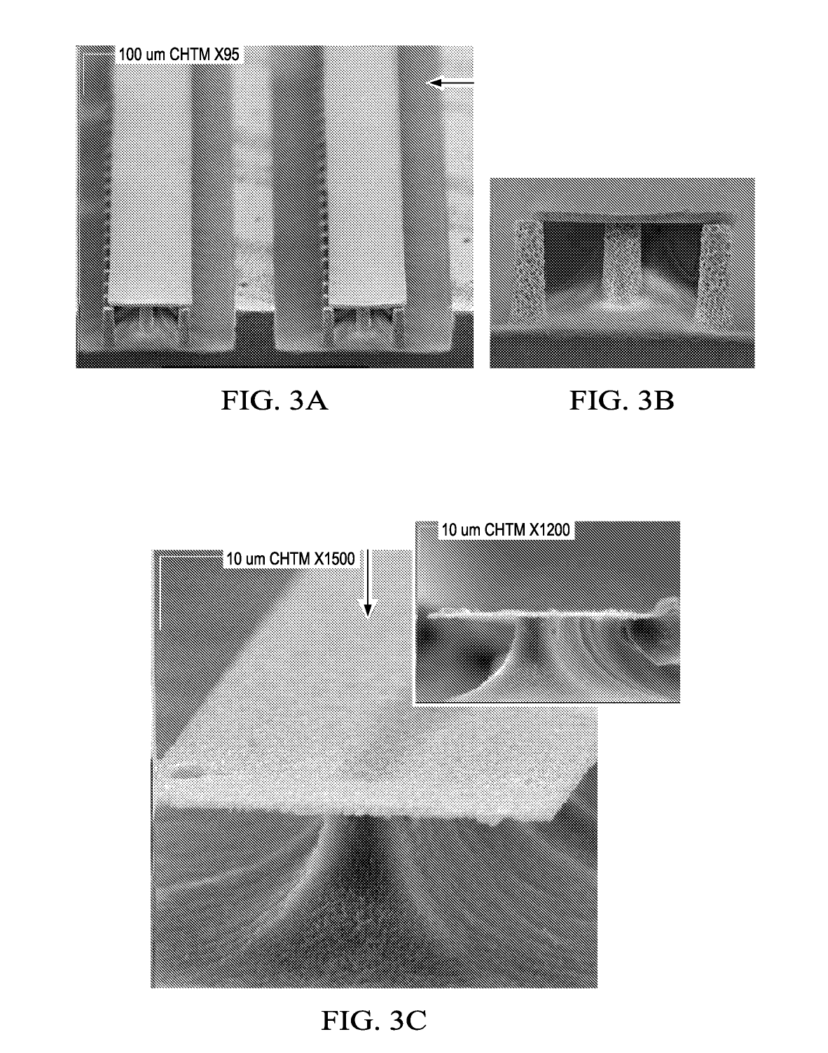

FIGS. 3A-3C are images of metal rails for more efficient RF electronics.

Below is a table comparing the characteristics of the standard processing verses champion processing.

| | | | | |
|---|---|---|---|---|
| TGV | >20 μm | ±10% | 9.6 μm | ±150 nm |
| | (Squares, circles, | | | |
| | lines, logos) | | | |
| TGV Aspect Ratio | 10:1 | n/a | 13:1 | n/a |
| TGV sidewall angle | >89° | n/a | >89° | n/a |
| TGV Sidewall Roughness | 1.25 μm Ra | ±0.25 μm Ra | 500 nm Ra | ±100 nm Ra |
| | (Scalloped) | | (annealed) | |
| Blind Via | >20 μm | ±10% | 5 μm | ±2μ |
| (Includes trenches, | | | | |
| cavities, etc.) | | | | |
| Trench, cavity depth | Min: 25 μm | ±10% | 5:1 aspect ratio | ±5 μm |
| | Max: 900 μm | | | |
| Wafer Thickness | 250-500, 1000 μm | ±25 μm | 100 μm | ±10 μm |
| Surface Finish | 100 nm Ra | ±50 nm Ra | 20 A Ra | n/a |
| Hermetic Copper | >40 μm diameter | | 15 μm diameter | |
| Filled TGV | (8:1 aspect ratio) | | (8:1 aspect ratio) | |

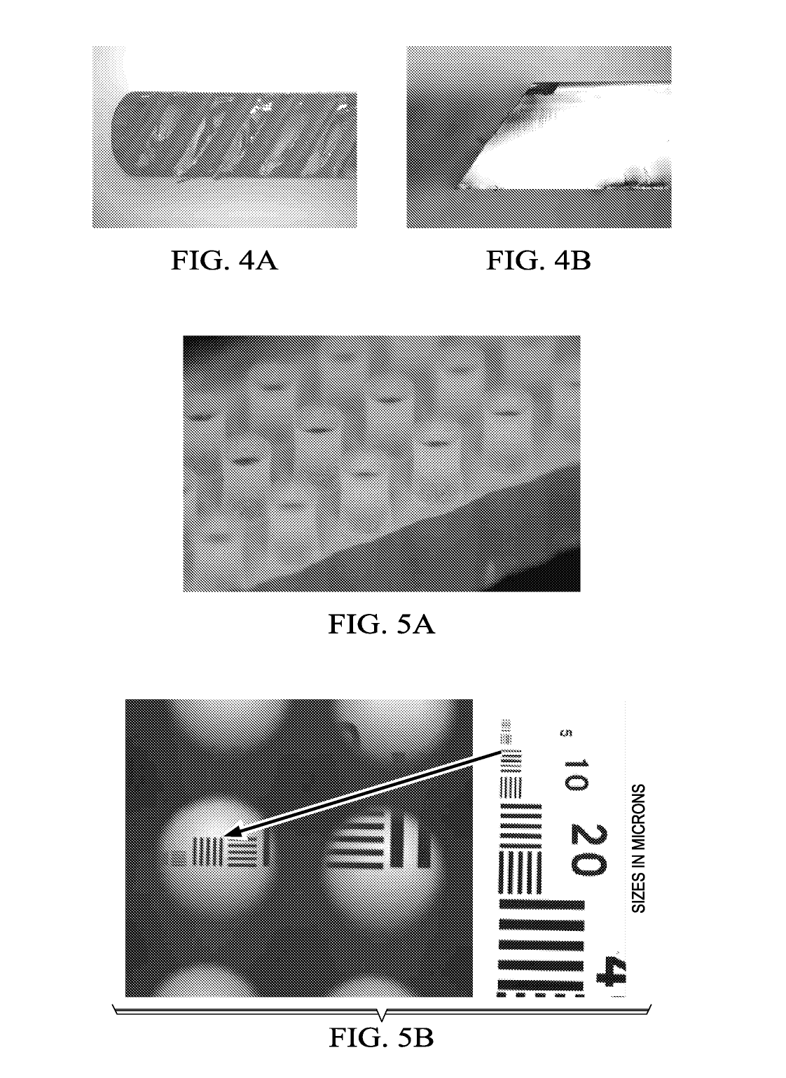

FIGS. 4A and 4B are images of the angled etched features of the present invention the angles can be at any angle from 0-45 degrees.

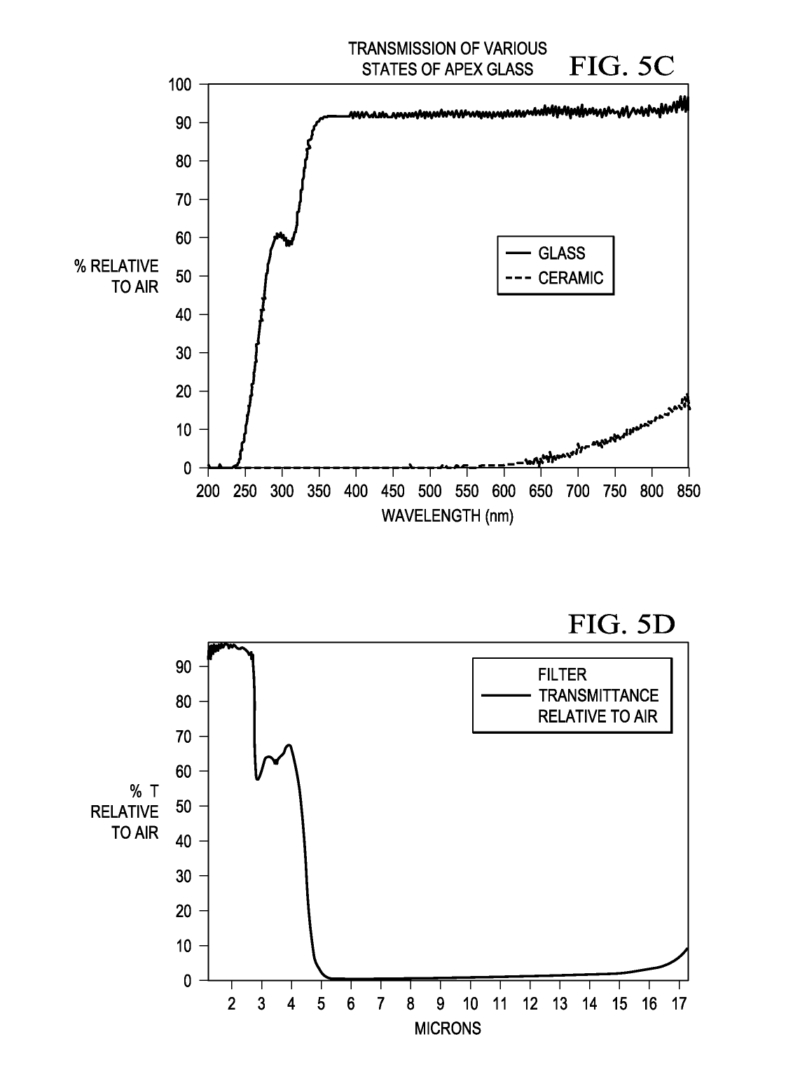

FIGS. 5A-5D are images of the spatially resolved optical elements and accompanying graphs.

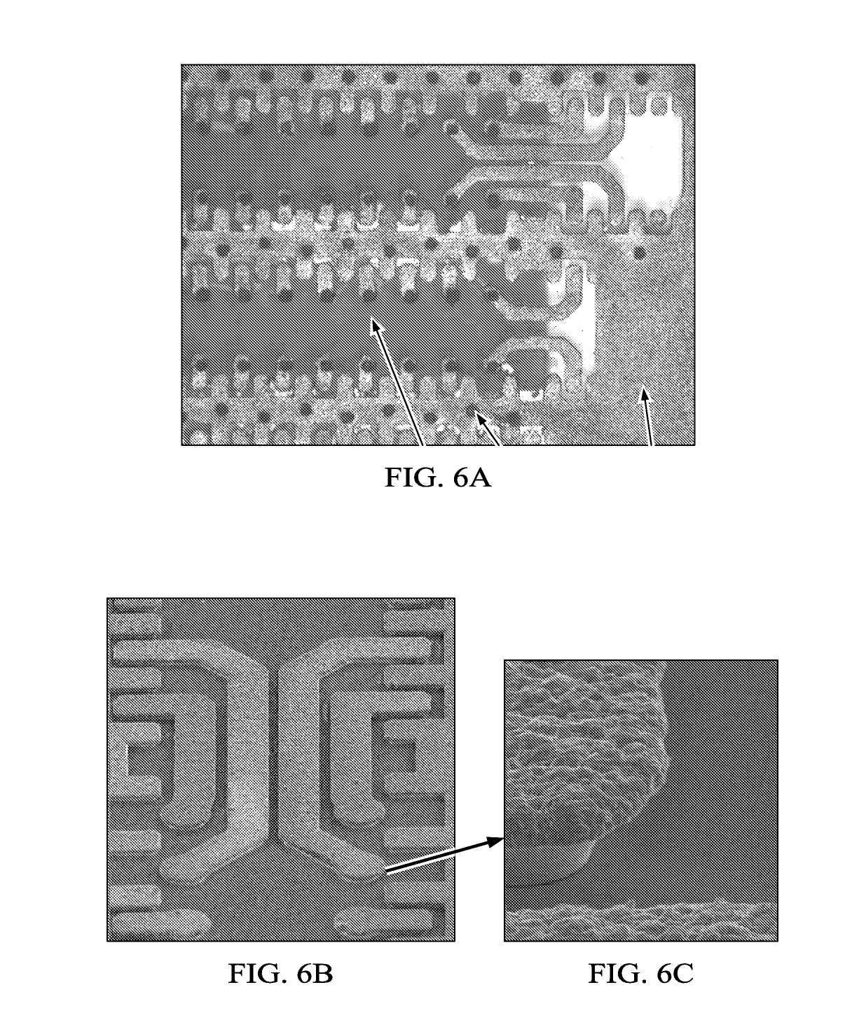

FIGS. 6A-6C are images of the processing and metal adhesion to the glass substrate of the instant invention.

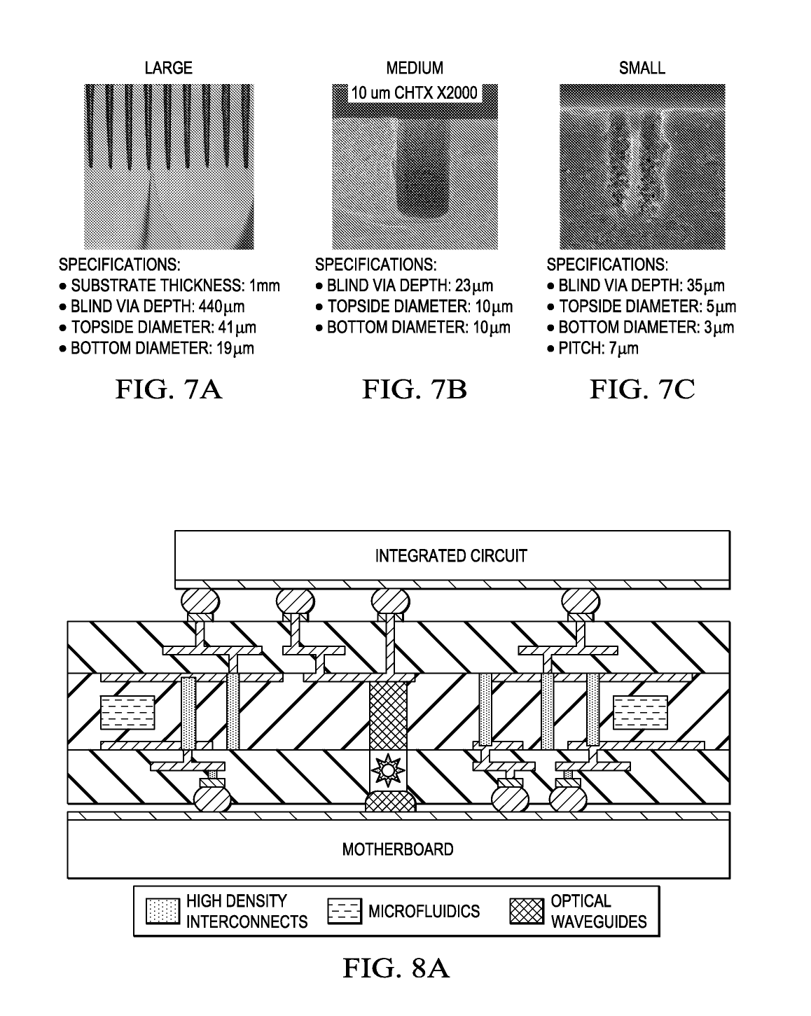

FIGS. 7A-7C are images of the blind vias.

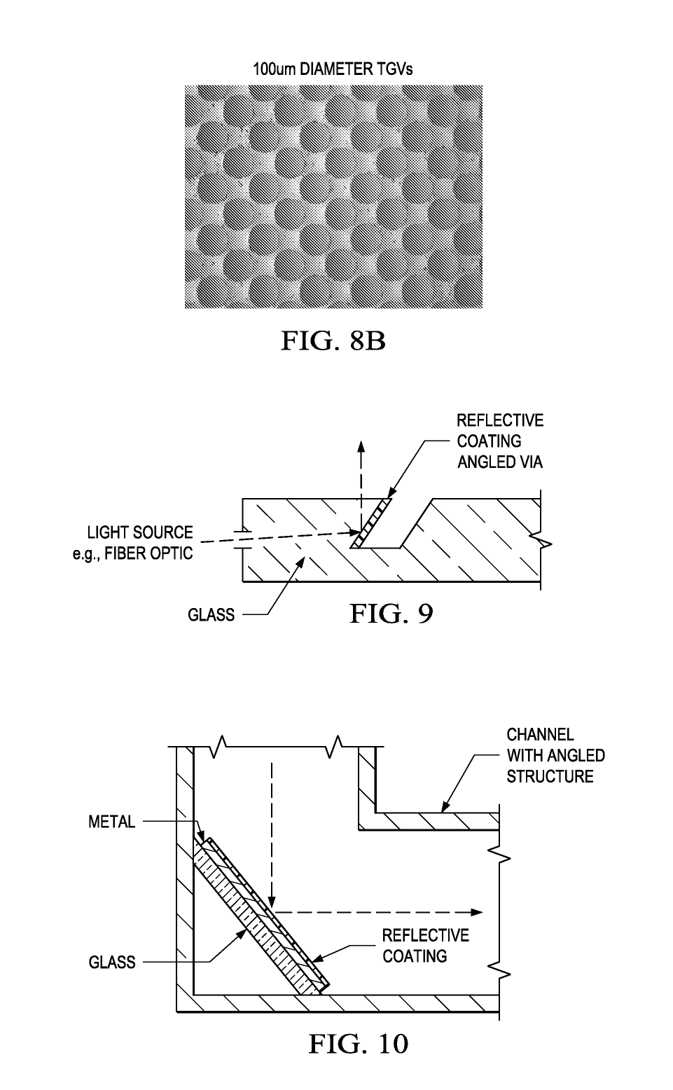

FIGS. 8A and 8B are images of an integrated circuit and an image of TGVs. FIG. 8A is an image of a device that is glass (A), contain regions of two or more of the following: glass, ceramic, or precipitated nucleating agent (B), wholly precipitated nucleating agent (e.g., gold, silver, copper, etc) (C), or wholly ceramic (D). APEX™ GC would be an example of a photodefinable glass ceramic. As such, the present invention provides a platform for microprocessors/semiconductor processing where a CPU chip may be mounted to an APEX™ GC device that contained ultra fine plated through holes for electrical conduction from CPU to the external components of the device, microfluidics for in-package cooling, optical wave guides for optoelectronic computing, and/or imbedded passive devices. Additionally, this approach may be used for other SiP, PoP, PiP, and SoC stack structures.

FIG. 9 is an image of one embodiment of the present invention including an angled channel with a reflective coating such that the light may pass and be reflected in a different angle.

FIG. 10 is an image of one embodiment of the present invention including a angled channel with a reflective coating such that the light may pass and be reflected in a different angle.

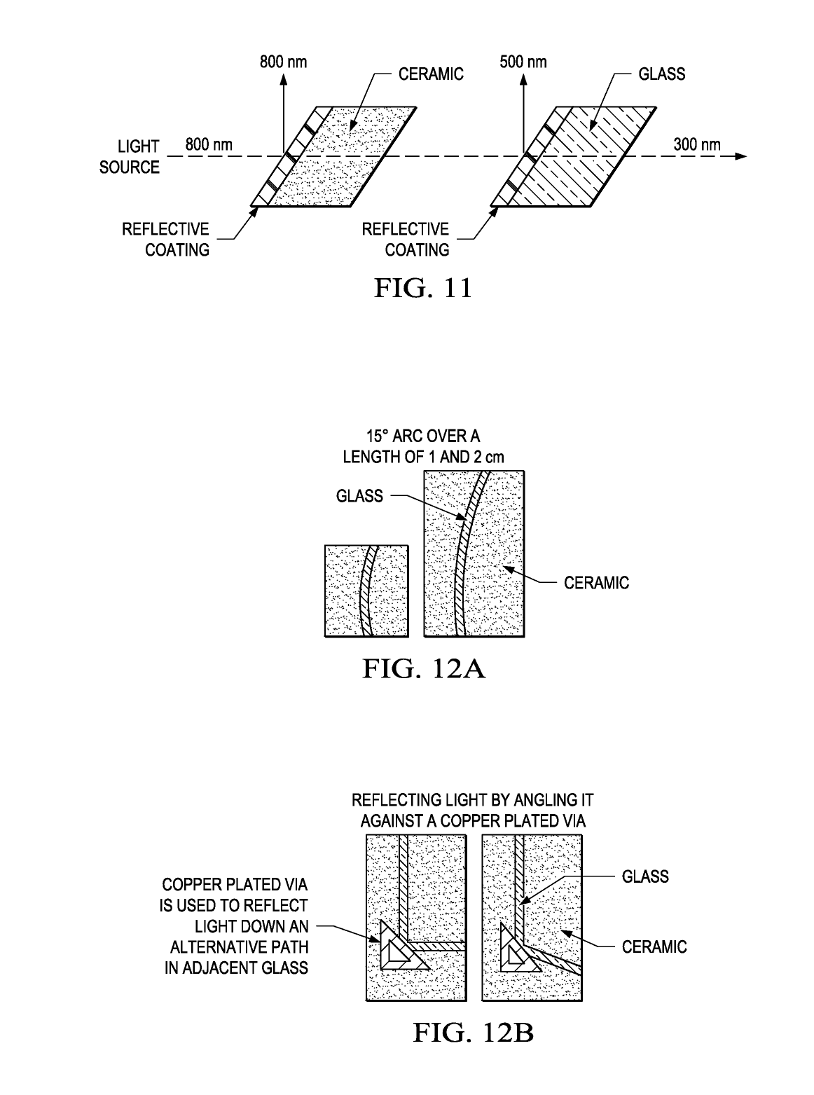

FIG. 11 is an image of a filter wherein a first coated angled surface is positioned to reflect a specific wavelength while allowing other wavelengths to pass through. A second coated angled surface is positioned to reflect a specific wavelength while allowing other wavelengths to pass through. This setup can be repeated numerous times. In addition, other embodiments will have some or all of the wavelengths reflected or passed depending on the specific needs of the skilled artisan.

FIG. 12A is an image of a quartz/chrome mask containing a variety of arcs with different angles and lengths and FIG. 12B is an image of reflection of light by angling it against a copper plated via to reflect light down an alternative path in the adjacent glass. In addition, the present invention provides a method of forming optical wave guiding in APEX™ Glass ceramic. The glass ceramic of the present invention is unique in that even when the final product is in the ceramic state, it may contain specified regions of glass. This glass may transverse along a layer as well as through several layers. This aspect is accomplished with one slight modification to previously described ceramicization protocols. Above, ceramicization of the glass is accomplished by exposing the entire glass substrate to approximately 20 J/cm² of 310 nm light. When trying to create glass spaces within the ceramic, users expose all of the material, except where the glass is to remain glass.

In one embodiment, the present invention provides a quartz/chrome mask containing a variety of arcs with different angles and lengths (as seen in FIG. 12A). The angles of these arcs can range from 0-15° (or 1-90°) and increase by 1° or more increments. Lengths of these arcs are be 1, 2, and 3 cm but can be any length necessary. In addition to arcs, the present invention provides for the strategic placement of copper plated vias directly adjacent to orthogonal and angled straight lines. FIG. 127B is an image of reflection of light by angling it against a copper plated via to reflect light down an alternative path in the adjacent glass. In these embodiments the plated vias act as mirrors for incoming light to dramatically change the angle)(>45° of light movement. The optical waveguide chips can be fabricated out of 1.0 mm thick APEX™ Glass ceramic and have channel widths of 300 and 600 microns, again different widths can be used, e.g., 0-300 or 600 or more microns. Although almost any light wavelength may be used (e.g., 1-1000 nm) some specific sources include LEDs at approximately 500 nm, 600 nm and 750 nm.

The present invention includes a method for fabricating a glass ceramic structure for use in forming angled structures, mirrors and glass ceramic materials used in electromagnetic transmission and filtering applications. The glass ceramic substrate may be a photosensitive glass substrate having a composition of: 60-76 weight % silica; at least 3 weight % K₂O with 6 weight %-16 weight % of a combination of K₂O and Na₂O; 0.003-1 weight % of at least one oxide selected from the group consisting of Ag₂O and Au₂O; 0.003-2 weight % Cu₂O; 0.75 weight %-7 weight % B₂O₃, and 6-7 weight % Al₂O₃; with the combination of B₂O₃; and Al₂O₃ not exceeding 13 weight %; 8-15 weight % Li₂O; and 0.001-0.1 weight % CeO₂. This varied composition is generally referred to as the APEX.

At least one portion of the photosensitive glass substrate is exposed to ultraviolet light, while leaving at least a second portion of said glass substrate unexposed; the glass substrate is heated to a temperature near the glass transformation temperature to transform at least part of the exposed glass to a crystalline material; and the glass substrate is etched in an etchant, wherein the etch ratio of exposed portion to that of the unexposed portion is at least 30:1 when exposed with a broad spectrum mid-ultraviolet flood light, and greater than 30:1 when exposed with a laser, to provide a shaped glass structure with an anisotropic-etch ratio of at least 30:1. Percentages herein are in weight percent of the constituents.

The present invention includes a method for fabricating a glass ceramic structure for use in forming angled structures, mirrors and glass ceramic materials used in electromagnetic transmission and filtering applications. The glass ceramic substrate may be a photosensitive glass substrate having a composition of: 60-76 weight % silica; at least 3 weight % K₂O with 6 weight 16 weight % of a combination of K₂O and Na₂O; 0.003-1 weight % of at least one oxide selected from the group consisting of Ag₂O and Au₂O; 0.003-2 weight % Cu₂O; 0.75 weight %-7 weight % B₂O₃, and 6-7 weight % Al₂O₃; with the combination of B₂O₃; and Al₂O₃ not exceeding 13 weight %; 8-15 weight % Li₂O; and 0.001-0.1 weight % CeO₂. This varied composition is generally referred to as the APEX.

At least one portion of the photosensitive glass substrate is exposed to ultraviolet light, while leaving at least a second portion of said glass substrate unexposed; the glass substrate is heated to a temperature near the glass transformation temperature to transform at least part of the exposed glass to a crystalline material; and the glass substrate is etched in an etchant, wherein the etch ratio of exposed portion to that of the unexposed portion is at least 30:1 when exposed with a broad spectrum mid-ultraviolet flood light, and greater than 30:1 when exposed with a laser, to provide a shaped glass structure with an anisotropic-etch ratio of at least 30:1. Percentages herein are in weight percent of the constituents.

This photosensitive, shaped glass structure can be composed of: 35-76 weight % silica, 3-16 weight % K2O, 0.003-1 weight % Ag2O, 0.75-13 weight % B2O3, 8-15 weight % Li2O, and 0.001-0.1 weight % CeO2. This photosensitive glass is processed using at least one of the following steps: At least one portion of the photosensitive glass substrate is exposed to ultraviolet light, while leaving at least a second portion of said glass substrate unexposed; the glass substrate is heated to a temperature near the glass transformation temperature to transform at least part of the exposed glass to a crystalline material; and the glass substrate is etched in an etchant, wherein the etch ratio of exposed portion to that of the unexposed portion is at least 30:1 when exposed with a broad spectrum mid-ultraviolet flood light, and greater than 30:1 when exposed with a laser, to provide a shaped glass structure with an anisotropic-etch ratio of at least 30:1.

The present invention includes a method for fabricating a glass ceramic structure for use in forming angled structures, mirrors and glass ceramic materials used in electromagnetic transmission and filtering application and may include a photosensitive glass substrate having a composition of: 46-76 weight % silica, 3-16 weight % K2O, 0.003-1 weight % Ag2O, 0.75-13 weight % B2O3, 6-7 weight % Al2O3, 11-15 weight % Li2O, and 0.001-0.1 weight % CeO2. The photosensitive glass is processed using at least one of the following steps: At least one portion of the photosensitive glass substrate is exposed to ultraviolet light, while leaving at least a second portion of said glass substrate unexposed; the glass substrate is heated to a temperature near the glass transformation temperature to transform at least part of the exposed glass to a crystalline material; and the glass substrate is etched in an etchant.

Some embodiments are essentially germanium-free. In some embodiments, Sb₂O₃ or As₂O₃ is added (e.g. at least 0.3 weight % Sb₂O₃ or As₂O₃) to help control the oxidation state of the composition. In some preferred embodiments, at least 0.75 weight % B₂O₃ is included, and in others at least 1.25 weight % B2O3 is included. In some preferred embodiments, at least 0.003% Au₂O is included in addition to at least 0.003 weight % Ag₂O. In some embodiments, a combination of CaO and/or ZnO is added up to 18 weight %. In some embodiments, up to 10 weight % MgO is added. In some embodiments, up to 18 weight % lead oxide is added. Up to 5 weight %, Fe₂O₃, may be added to make the material paramagnetic and iron (II) and iron (III) may be added as a quenching agent to reduce autofluorescence of the glass.

Preferably, the glass substrate is heated to a temperature of 420-520C for between 10 minutes and 2 hours and then heated to a temperature range heated to 520-620C for between 10 minutes and 2 hours.

In some embodiments, the etchant is HF, in some embodiments the etchant is a combination of HF and additional ingredients, such as hydrochloric acid or nitric acid. The preferred wavelength of the ultraviolet light used for exposure is approximately 308-312 nm.

In one embodiment, the photosensitive glass substrate may have one or more patterned structure and a glass composition of about 60-76 weight % silica, 6 weight %-16 weight % of a combination of K2O and Na2O with at least 3 weight % K2O, 0.001-1 weight % Ag2O, 0.75 weight %-7 weight % B2O3, and 5-8 weight % Al2O3, with the combination of B2O3, and Al2O3 not exceeding 13 weight %, 8-15 weight % Li2O, and 0.04-0.1 weight % CeO2.

The patterned structure may have at least one portion exposed to an activating energy source such as ultraviolet light and at least a second portion of the glass substrate not exposed to the ultraviolet light. Part of this exposed portion may be transformed into a crystalline material by heating the glass substrate to a temperature near the glass transformation temperature.

Preferably, the shaped glass structure contains at least one of: an angled surface, a channel, a micro-optic lens, a micro-optic micro-post, a micro-channel, or micro-ridge micro-optic waveguide. The micro-ridge, optical waveguide may be formed by etching away exposed glass to leave a glass micro-ridge such that light is guided by the micro-ridge. The micro-ridge may be formed using a layer of photosensitive glass overlying a layer of non-photosensitive glass of lower index of refraction than the photosensitive glass, to substantially prevent micro-ridge-guided light from leaving the bottom of the micro-ridge in at least one portion of the micro-ridge (e.g. bottom vias may be etched in the non-photosensitive glass to allow light coupling to a light guide on a lower level).

In this embodiment, the composition ontain at least 0.5 weight % B2O3 or contain at least 1.25 weight % B2O3, contain at least 0.3 weight % Sb2O3 or As2O3, contain 0.003-1 weight % of at least one of Au2O and Ag2O, contains 1-18 weight % of an oxide such as of CaO, ZnO, PbO, MgO and BaO, contain 0-5 weight %, iron (Fe2O3) to make the composition paramagnetic and/or to use iron (II) and iron (III) to quench intrinsic autofluorescence, and contain up to 2 weight % Copper Oxide. The shaped glass structure may also have an anisotropic-etch ratio of about 30-45:1.

In another embodiment, the photosensitive glass substrate may have one or more patterned structure, and a glass composition of about 35-76 weight % silica, 3-16 weight % K2O, 0.001-1 weight % of at least one oxide such as Ag2O and Au2O, 0.75-13 weight % B2O3, 8-15 weight % Li2O, and 0.0014-0.1 weight % CeO2.

In this embodiment, the patterned structure may have at least one portion exposed to an activating energy source such as ultraviolet light and at least a second portion of the glass substrate not exposed to the ultraviolet light. In some embodiments, excimer lasers at 248 nm or the 3rd harmonic of Nd:YAG lasers at 355 nm are used to expose the photosensitive glass. Part of this exposed portion may be transformed into a crystalline material by heating the glass substrate to a temperature near the glass transformation temperature. When etching the glass substrate in an etchant such as hydrofluoric acid, the anisotropic-etch ratio of the exposed portion to the unexposed portion is at least 30:1 when the glass is exposed to a broad spectrum mid-ultraviolet (about 308-312 nm) flood lamp to provide a shaped glass structure with an aspect ratio of at least 30:1, and to provide shaped glass structures when the glass is exposed using a high powered energy source, such as a laser. In addition, the composition of the shaped glass structure may essentially be germanium-free, contain at least 0.5 weight % B2O3 or at least 1.25 weight % B2O3.

In another embodiment, the present invention is a shaped glass having a photosensitive glass substrate with a glass transformation temperature. The photosensitive glass substrate may have one or more patterned structure, and a glass composition of about 46-76 weight % silica, 3-16 weight % K2O, 0.001-1 weight % Ag2O, 0.5-13 weight % B2O3, 8-15 weight % Li2O, and 0.001-0.1% CeO2. For example, the photosensitive glass substrate may have one or more patterned structure, and a glass composition of about 45, 50, 55, 60, 70, 75 or 76 weight % silica; 3, 5, 7, 8, 10, 12 or 16 weight % K2O; 0.001, 0.01, 0.1, 0.25, 0.5, 0.75 or 1 weight % Ag2O; 0.5, 1, 2.5, 5, 7.5, 10, 12.5 or 13 weight % B2O3; 8, 7, 9, 10, 12.5 or 15 weight % Li2O; and 0.001, 0.01, 0.05 or 0.1% CeO2.

In this embodiment, the patterned structure may have at least one portion exposed to an activating energy source such as ultraviolet light and at least a second portion of the glass substrate not exposed to the ultraviolet light. Part of this exposed portion may be transformed into a crystalline material by heating the glass substrate to a temperature near the glass transformation temperature. When etching the glass substrate in an etchant such as hydrofluoric acid, the anisotropic-etch ratio of the exposed portion to the unexposed portion is at least 30:1 when the glass is exposed to a broad spectrum mid-ultraviolet (about 308-312 nm) flood lamp to provide a shaped glass structure with an aspect ratio of at least 30:1, and to provide shaped glass structures with an aspect ratio much greater than 30:1 when the glass is exposed using a high powered energy source, such as a laser.

Patterned glass structures that may be formed include micro-optic lenses, micro-optic micro-posts, and micro-optic waveguides such as micro-channels, micro-ridges (exposed glass is etched away to leave a glass micro-ridge), and index of refraction guides formed by patterned exposure of the glass.

In some embodiments, the patterned glass structure is processed by flood exposing to 300-320 nm light and heated to a temperature near its glass transformation temperature to allow at least part of the reduced noble metal to coalesce to provide a patterned glass structure is used to form larger clusters for at least one plasmon analytical technique, e.g. surface enhanced fluorescence, surface enhanced Raman spectroscopy, and surface plasmon resonance.

In some embodiments, the patterned glass structure forms at least part of a multilayer optical printed circuit board. This may also be a method to make a micro-optical interconnection apparatus, comprising: preparing a first photosensitive glass layer having a first glass transformation temperature and having a composition comprising: less than 76% silica, at least 0.0008% of at least one of a noble metal oxide and/or a copper oxide, at least 11% Li2O, and at least 0.0014% CeO2; exposing a first set of paths in the first photosensitive glass layer with ultraviolet light 240 to 360 nm light or a directed source of protons, while leaving at least a second portion of the first glass layer unexposed; depositing an ultraviolet-light reflecting-or-absorbing layer on the first layer; depositing a layer of non-photosensitive glass on the ultraviolet-light reflecting-or-absorbing layer; patterning and etching vias in the ultraviolet-light reflecting-or-absorbing layer and the non-photosensitive glass layer to provide light-coupling vias; depositing a second photosensitive glass layer on the patterned and etched non-photosensitive glass, the second photosensitive glass layer having a second glass transformation temperature and having a composition comprising, less than 72% silica, at least 0.008% of at least one of a noble metal oxide and a copper oxide, at least 11% Li2O, at least 0.75% B2O3, and at least 0.0014% CeO2, wherein the second photosensitive glass layer has a higher index of refraction than the non-photosensitive glass; exposing a second set of paths in the second photosensitive glass layer with ultraviolet light 300 to 320 nm light or a directed source of protons, while leaving at least a second portion of the second photosensitive glass layer unexposed; and heating the photosensitive glass layers to above their glass transformation temperatures to raise the index of refraction of the first and second sets of paths to render the sets of paths light-guiding.

This may also be a method to make a micro-optical interconnection apparatus, comprising: preparing a first photosensitive glass layer having a first glass transformation temperature; exposing a first set of paths in the first photosensitive glass layer with ultraviolet light 240 to 360 nm light or a directed source of protons, while leaving at least a second portion of the first glass layer unexposed; depositing an ultraviolet-light reflecting-or-absorbing layer on the first layer; depositing a layer of non-photosensitive glass on the ultraviolet-light reflecting-or-absorbing layer; patterning and etching vias in the ultraviolet-light reflecting-or-absorbing layer and the non-photosensitive glass layer to provide light-coupling vias; depositing a second photosensitive glass layer on the patterned and etched non-photosensitive glass, the second photosensitive glass layer having a second glass transformation temperature and having a composition comprising, less than 72% silica, at least 0.008% of at least one of a noble metal oxide and a copper oxide, at least 11% Li2O, at least 0.75% B2O3, and at least 0.0014% CeO2, wherein the second photosensitive glass layer has a higher index of refraction than the non-photosensitive glass; exposing a second set of paths in the second photosensitive glass layer with ultraviolet light 300 to 320 nm light or a directed source of protons, while leaving at least a second portion of the second photosensitive glass layer unexposed; and heating the photosensitive glass layers to above their glass transformation temperatures to raise the index of refraction of the first and second sets of paths to render the sets of paths light-guiding.

The present invention provides a single material for denser packaging with imbedded optical waveguides, and cooling. Packaging is the final manufacturing step in semiconductor processing, transforming semiconductor parts into saleable devices. Unfortunately, today's packaging has become the limiting element in system cost and performance for IC development. As packaging enables consumer control (directly and indirectly) of electrical connections, signal transmission, power inputs, and voltage control. As the traditional Moore's Law scaling has become more and more difficult, innovation in packaging is expected to provide similar scaling in performance and cost. Assembly and packaging technologies have become primary differentiators for manufactures of consumer electronics and the push for small IC products.

Applications of the present invention reduce form factors and include cellular phones, digital video camcorders, and notebook PCs among others. Traditional packaging approaches to address the needs in these “High Density Portable” devices, e.g., FR4, liquid crystal polymers, and Low Temperature Co-Fired Ceramics (LTCC), running into fundamental material limitations (e.g., packaging layer thinness, high density interconnect capability, thermal management, and optical waveguiding). APEX™ Glass is a photo definable glass-ceramic. APEX™ Glass ceramic is process using first generation semiconductor equipment in a simple three step process and the final material may be either glass, ceramic, or contain regions of both glass and ceramic.

Generally, glass ceramics materials have had limited success in microstructure formation, they have been plagued by performance, uniformity, usability by others and availability issues. Legacy glass-ceramic options produced maximum etch aspect-ratios of approximately 15:1 in contrast APEX glass has an average etch aspect ratio greater than 50:1. This allows users to create smaller and deeper features. Additionally, our manufacturing process enables product yields of greater than 90% (legacy glass yields are closer to 50%). Lastly, in legacy glass ceramics, approximately only 30% of the glass is converted into the ceramic state, whereas with APEX™ Glass ceramic this conversion is closer to 70%. This translates into the faster, more precise, etching of ceramic features.

Surprisingly, it was found that the compositions of the present invention may at first glance appear to be similar to FOTURAN®; however, there are dramatic differences with the compositions of the present invention. For example, the instant invention demonstrated a surprising sensitivity to ultraviolet light exposure of over three times that of the commercially available photosensitive glass, and yielded up to six times the etch rate more compared to FOTURAN® when both compositions were processed in the way recommended for FOTURAN® (with the exception of the reduced exposure and bake temperature used for APEX due to its greater sensitivity and lower glass transformation temperature). Further, APEX glass had an etch ratio of exposed portion to that of the unexposed portion of at least 30:1 to 40:1, while the best reported etch ratio of the commercially available FOTURAN® photosensitive glass exposed with a broad spectrum mid-ultraviolet flood lamp is about 20:1.

Not wanting to be bound by theory, it is believed that changes in the APEX composition provides three main mechanisms for its enhanced performance: (1) The higher amount of silver leads to the formation of smaller ceramic crystals which are etched faster at the grain boundaries, (2) the decrease in silica content (the main constituent etched by the HF acid) decreases the undesired etching of unexposed material, and (3) the higher total weight percent of the alkali metals and boron oxide produces a much more homogeneous glass during manufacturing. This facilitates more consistent performance across the substrate over large distances—but in any case, the results are surprising.

Kravitz et al. (U.S. Pat. No. 7,132,054), suggests that an even less expensive method of fabricating the microneedles is to replicate them using a negative mold made from the original glass hollow microneedle array structure, as follows: “A negative mold can be made by depositing a mold material onto the glass hollow microneedle array. For example, a negative mold of FOTURAN®. Microneedles can be made by electroplating a metal (e.g., nickel, copper, or gold) onto a sputtered seed layer deposited on the FOTURAN® microneedles. After the negative plated mold is created and released from the glass array, a liquid polymer, such as Zeonor 1020R, can be cast into the mold. After the Zeonor 1020R is cooled and solidified, the polymeric hollow microneedle array can be easily peeled off the plated negative mold and the mold can be re-used. Other plastics that can be hot embossed or injection molded, such as polycarbonate, can also be used.” Such an approach can be improved by using APEX. Alternatively, a negative mold can be made directly of the photoetchable glass, as shown in U.S. Pat. No. 7,132,054. A similar process can be used with the glass ceramics of the present invention as such U.S. Pat. No. 7,132,054 is hereby incorporated by reference.

The present invention provides a single material approach for the fabrication of microstructures with photodefinable/photopatternable glass ceramics (GCs) for use in ultra fine plated through holes for conduits for electrical/electron movement; semiconductor placed (e.g. thermal evaporation, sputter, etc.) electrical lines; microfluidics for on-chip/in-package cooling and fluid movement and operate on a high pressure or low pressure based. The architecture may also be optical wave guiding for optoelectronic devices or optical interrogation of a sample that can include the shaped GC structures that are used for lenses and includes through-layer or in-layer designs. The present invention can also provide cut outs within layers for embedded devices between layers, such as imbedded passive devices or fluidic reservoirs.

In addition to semiconductor applications, the present invention can be used to form microfluidic channels, created to withstand ultra high pressures (>10,000 psi) to be used for chip-based HPLC. The microfluidics of the present invention may be packed with microspheres and be used for analyte separation. Furthermore, the whole system may be fully or partially ceramicized. In the fully ceramicized example it may contain a small window of glass (e.g., an optical wave guide) surrounded by ceramic for optical viewing into the channel. Other embodiments of the instant invention use the architecture features disclosed herein without the use of the electronics portion in non-semiconductor packaging design, e.g., HPLC design.

In any of the embodiments herein, the electron conduction elements can be of any metal (such as gold, platinum, and copper) and alloys or mixtures thereof can be incorporated through a variety of methods including electroless plating, electroplating, thermal evaporation, sputtering, or epoxy. In some embodiments, other conductive mediums (e.g., conductive polymers or conductive diamond) may be used.

The present invention provides many benefits including a semiconductor approach to packaging manufacturing, improved planarity with reduced or low warpage at higher process temperatures due to increased glass transition temperature (Tg) and modulus, low moisture absorption, increased via density in substrate core, alternative plating finish for improve reliability, a solution for interconnect density scaled to silicon (Si I/O density increases faster than package substrate technology), Tg compatible with Pb-free solder processing including rework at 260° C., thermal dissipation and heat management. For example, the heat transfer rate in fully ceramicized parts measured a 10% better than glass parts.

In addition, the ceramicized APEX™ GC of the instant invention provides many benefits not seen with borosilicate, e.g., thinner package sizes to fit into thinner-demanded electronics, continuation of the Moore's law-like advancement in semiconductors, higher operating temperature for processors, halogen free, no need for fire-retardant coatings, no need for UL-94 qualification (i.e., the parts will no longer be plastic), better at higher frequencies, more consistent dielectric constant, the ability to produce numerous structures (e.g., vias, optics, channels) simultaneously, does not require costly and slow CNC milling, provides higher aspect ratio of through holes (>50:1 vs. 8:1) compared to FR4, provides better and smaller through hole diameters and pitches, the present invention may be engineered to be radiation hard glass-ceramic and provide a more controllable manufacturing process with final products with portions that are optically transparent surrounded by non-transparent ceramic.

The present invention provides a method of IC packages made out of ceramics (e.g., LTCC and HTCC) plastics (e.g., liquid crystal polymers) and hybrid organic materials (e.g., FR4). APEX™ Glass ceramic and other GCs have certain properties that are ideally suited for future packaging applications such as: Tg, Modulus, semiconductor processing, and advanced engineering features (e.g., waveguiding, microfluidics, through hole density).

The present invention provides numerous methods of processing. For example, one embodiment has a process using APEX™ GC but not limited thereto. The present invention provides a single feature or serial feature microfabrication that includes exposing features into a raw GC substrate with 310 nm light, baking the parts and convert regions previously exposed into ceramic. The parts are etched in dilute HF acid to obtain a final structure. Each layer is processed accordingly. In the case of serial processing, other features on previously processed layers are created in this step by the following steps. For example, the first processing would be through holes for high d. The layers are then exposed to 310 nm light with no mask. Alternatively, the regions are exposed, except regions with the wave guides (e.g., glass surrounded by precipitated nucleating agent or ceramic are to remain) to 310 nm light. The layers are aligned to form a complete device, baked and ceramicized all layers together. Alternatively, this process may be done separately (e.g., ceramicize then bond) or it can be done at the same time (e.g., ceramicized and bond).

In another embodiment, the features and benefits of the material can be achieved through a deposition method. For example, the core photodefinable glass may be deposited via CFD, ionic plasma deposition, or other surface coating methods, to a compatible substrate and yield similar capabilities. Additionally, a sol-gel processed GCs may be used for this purpose. There may be an annealing steps if needed where the GC final product is annealed at T>Tg for a several hours. This would create a better ceramic and increase the bonding strength of the previously bonded layers based on the formation of crystallized structure versus the amorphous glass phase of the GC.

The present invention allows the design of cooling and optical waveguides. Cooling is currently accomplished by air-cooled heat sinks. Today's cooling methods rely upon large thermal mass heat sinks. These devices limit the chip packing density, and increase wiring length, which contributes to higher interconnect latency, higher power dissipation, lower bandwidth, and higher interconnect losses. APEX™ Glass ceramic of the present invention is currently used for the production of microfluidics for biological and chemical reactions and thus provides a ready reference product for in-package microfluidic cooling.

Furthermore, the APEX™ glass ceramic of the present invention has the ability to create microstructures of optically transparent glass surrounded by non-transparent ceramic. These glass waveguides can be produced either vertically or horizontally within multi-layer packages. In the processing of waveguides areas of reduced index of refraction (ceramic) surround areas of increased index of refraction (glass). The intermediate integration of optoelectronic devices onto packaging structures will address the key bottleneck of low-latency, high-bandwidth, and high density off-chip interconnects.

One electroplating system for interconnect coatings that can be used is a LPKF Contact-RS system that uses reverse-pulse electroplating to produce smooth interconnect wall plating without creating copper over-plating. The LPKF system is capable of plating up to 6 layers. Another system is an electroless plating that is a cost effective way of plating copper without electronic controls and is generally used for copper deposition in interconnect plating.

The present invention provides a process to form devices such as vias and microfluidic channels are simultaneously microfabricated in a fast and cheap process. The first step involves patterning an APEX™ Glass ceramic wafer using standard contact photolithography processes with a quartz/chrome mask to create the desired pattern. The wafer is then exposed to mid ultraviolet light. During this step, photo-activators in the glass become reduced. In the second step of the process, the wafer is baked in a two-step process. First, the temperature is raised to a level that allows the photo-activators to migrate together forming nano-clusters. A second temperature ramp is employed to facilitate lithium ions in the glass matrix to coalesce around the previously formed nano-clusters. During this step of the baking process, the exposed regions are converted into a ceramic. In the final step, the wafer is etched in a hydrofluoric solution creating posts, wells, vias, or other desired features. The desired structure height/depth can be controlled via etch concentrations and processing duration. Once the desired structures have been created the whole system can be converted into ceramic by exposing and baking the entire part.

Patterned glass structures that may be formed include micro-optic lenses, micro-optic micro-posts, and micro-optic waveguides such as micro-channels, micro-ridges (exposed glass is etched away to leave a glass micro-ridge), and index of refraction guides formed by patterned exposure of the glass (with or without baking).

The glass substrate may also be heated to a temperature in excess of the glass transformation temperature to allow at least part of the reduced noble metal to coalesce to provide a patterned glass structure is used to form larger clusters for at least one plasmon analytical technique, e.g. surface enhanced fluorescence, surface enhanced Raman spectroscopy, and surface plasmon resonance.

In some embodiments, the patterned glass structure forms at least part of a two or more layer optical printed circuit board. This may also be a method to make a micro-optical interconnection apparatus, comprising: preparing a first photosensitive glass layer having a first glass transformation temperature and having a composition comprising: less than 72% silica, at least 0.0008% of at least one of a noble metal oxide and/or a copper oxide, at least 11% Li₂O, and at least 0.0014% CeO₂; exposing a first set of paths in the first photosensitive glass layer with an activating energy source, such as an ultraviolet light (240 to 360 nm) or a directed source of protons, while leaving at least a second portion of the first glass layer unexposed; depositing an ultraviolet-light reflecting-or-absorbing layer on the first layer; depositing a layer of non-photosensitive glass on the ultraviolet-light reflecting-or-absorbing layer; patterning and etching vias in the ultraviolet-light reflecting-or-absorbing layer and the non-photosensitive glass layer to provide light-coupling vias; depositing a second photosensitive glass layer on the patterned and etched non-photosensitive glass, the second photosensitive glass layer having a second glass transformation temperature and having a composition comprising, less than 76% silica, at least 0.008% of at least one of a noble metal oxide and a copper oxide, at least 11% Li₂O, at least 0.75% B₂O₃, and at least 0.0014% CeO₂, wherein the second photosensitive glass layer has a higher index of refraction than the non-photosensitive glass; exposing a second set of paths in the second photosensitive glass layer with an activating energy source, such as ultraviolet light (300 to 320 nm) or a directed source of protons, while leaving at least a second portion of the second photosensitive glass layer unexposed; and heating the photosensitive glass layers to above their glass transformation temperatures to raise the index of refraction of the first and second sets of paths to render the sets of paths light-guiding.

While light can go from layer to layer vertically through vias, in some preferred embodiments light goes from layer to layer at a non-vertical angle. Light may be transferred through an elongated via using the same index of refraction in touching upper and lower light-guiding paths that overlap for some distance. Light may also be transferred through a less elongated via using a slightly higher index of refraction (higher than the touching upper and lower light-guiding paths) using 3-D patterning. The higher index of refraction can be produced by higher 3-D exposure using orthogonal laser beams focused on a series of points to create a pattern of higher index of refraction points leading between upper and lower light-guiding paths. The 3-D exposure can also create other structures, including corners of reduced radius (as compared to corners of constant index of refraction), polarizers, and diffraction gratings.

General Photoactive Glass Manufacturing Design Rules: Boron Oxide and Aluminum oxide basically conduct the same task within the glass melt. Boron oxide may also be in the form of anhydride boric acid (H₃BO₃), Borax Frits, Gerstley Borate/Colemanite, Boric Acid, Borax, and Ulexite. A 13 weight percent represents the high end of B₂O₃ in borosilicate glasses. Boron Oxide concentration range: Up to 13 weight percent. Aluminum oxide may be in the form of Alkali containing feldspars (such as Albite, NaAlSi₃O₈) or alumina hydrate. Al₂O₃ may be added by using kaolin or nepheline syenite (which contains feldspar). Up to 8 weight percent. This represents the high end of Al₂O₃ in borosilicate glasses crystallization Aluminum Oxide concentration range: up to 7 weight percent. Or more appropriately, the combination of Boron Oxide and Aluminum Oxide should not exceed 13 weight percent.

Potassium Oxide and Sodium Oxide basically conduct the same task within the glass melt. Potassium oxide: Helps lower melting point. Sometimes used to replace sodium in soda lime glasses. Range up to 16 weight percent as well. May also be Potash (K₂CO₃). If used to replace Na₂O, typically makes the glass more chemically resistant.

Potassium Oxide concentration range: up to 16 weight percent. Sodium oxide helps lower melting point. Range up to 16 weight percent (common high end for soda lime glass). May also be soda ash (Na₂CO₃) or Glauber's Salt (Na₂SO₄). Sodium oxide concentration range: up to 16 weight percent. Or more appropriately, the combination of these two should not exceed 16 weight percent. Silica: concentration range: 60-85 weight percent.

Zinc oxide: Improves chemical resistance, lowers thermal expansion, adds elasticity. Works similarly with CaO. Up to 18 weight percent in E-Glass. Zinc Oxide concentration range: up to 18 weight percent. Lithium Oxide: Aids in nucleation. Can be lithium carbonate. Lithium Oxide concentration range: 8-15 weight percent.

Cerium Oxide: Electron Donor. Cerium oxide concentration range: up to 0.1 weight percent. Antimonium trioxide: Oxygen donor. Antimonium trioxide (Sb₂O₃) concentration range: up to 0.5 weight percent. Arsenic Oxide: Oxygen donor. Arsenic oxide (As₂O₃): Electron Donor. Arsenic Oxide concentration range: up to 0.1 weight.

Silver Oxide concentration range: up to 1 weight percent. Gold Oxide concentration range: up to 1 weight percent. Copper Oxide concentration range: up to 2 weight percent.

The above ingredients might be at least partially replaced with the following compounds: Calcium Oxide: Improves chemical resistance, lowers thermal expansion, adds elasticity. Works similarly with ZnO. Up to 18 weight percent in E-Glass. Calcium Oxide concentration range: up to 18 weight percent. Magnesium Oxide: This is the upper end in E-glass. May be in the form of MgCO₃. Magnesium oxide concentrate range: up to 10 weight percent. Barium Oxide: Improves refractive index of the material without increasing the dispersive power. Used as a replacement for lead or lime. May also come in the form of BaCO₃. Barium Oxide concentration range: up to 18 weight percent. Lead Oxide: Improves refractive index of the material without increasing the dispersive power. Lead Oxide concentration range: up to 18 weight percent.

Iron may be added to the melt to make the material paramagnetic (e.g. Fe₂O₃). Iron oxide may additionally be used to quench intrinsic autofluorescence of other compounds within the glass. Iron Oxide Concentration range: up to 5 weight percent.

Processing parameters. Patterning of the selected area(s) by at least one process step selected from the group consisting of: Exposure—Exposing the glass substrate to an activating energy source, such as 310 nm light or a directed source of protons.

Baking—Baking typically occurs in a two step process. Temperature 1 allows for the coalescing of silver ions into silver nanoparticles and temperature 2 allows for the lithium oxide to form around the silver nanoparticles. However, we have been successful in doing a single ramp step.

Etching—Etching is done in an HF solution, typically 5-10 percent by volume. However, we can also add other fluids to the etch solution. For example, we can add hydrochloric or nitric acid to the etch solution. We've had good success in using this solution to obtain a smoother etch because it dissolves the silver nanoparticles. This etch is especially useful in the fabrication of structures and devices that require a smooth surfaces, such as micro-lenses and micro-channels (e.g. to guide fluids).

In the fabrication of the micro-channels and many MEM's devices many times it is important to have the ability to hermetically seal more than one layer together. In the case of the micro-channel these layers may consist of a top and/or bottom lid with at least one section containing the actual micro-channel. The hermetic seal is important for fluid or gas retention. APEX has been shown to bonds to itself between temperatures of 450C and 565C creating a hermetic seal and bonding in such a way that two individual pieces of glass become one piece of glass, making a solid device. The temperatures used to bond APEX to itself are low enough that many metallization procedures done prior to the bonding step will not be affected by the elevated temperature. Alternatively, bonding may be accomplished through the application of certain epoxy monomers, epoxy polymers, thin films, sol-gels or silanization chemistries further described below.

Minimum feature pitch: This is defined as how close features can be placed together. Our studies have shown the photoactive glass of the present invention has a slight advantage in placing very small features adjacent to one another, for example, adjacent features may be placed as close as 10 microns. Adjacent large and small features: This is defined as placing small (i.e. micron sized features) next to large (i.e., millimeter sized features). Both glasses present similar results.

Etch consistency across substrate: This may be defined as pattern yield. The photoactive glass of the present invention has been demonstrated to provide very similar structures across large distances (i.e. 4 inches) of produced glass. For example, Apex consistently produces a product yield greater than 75% of a 100 mm diameter wafer, whereas to our experience the commercially available photoactive glass yield less than 60%. This is extremely important in product manufacturing since high yields translate to lower overall costs. Not wanting to be bound by theory, it is believed that the increased concentration of alkali metals and boron oxide aid in creating a more homogeneous glass mixture, which leads to more consistent results across relatively large distances (inches vs. microns) on the substrate. Etch rate of non-exposed regions: This processing metric helps in the creation of high aspect-ratio features, as unexposed material (present in the glass state) is not preferentially etched. Not wanting to be bound by theory, it is believed that the lower silica content in the glass decreases its susceptibility to etching (e.g. via acids, such as HF). Max Etch Depth: This is defined as how deep into the substrate patterns can be created. The photoactive glass of the present invention has the ability to create deeper features, for example greater than 2 mm etch depth.

Transparency of non-exposed regions after etch: Due to the observed decrease etch rate of non-exposed regions, the glass remains more transparent. Ability to thermally bond to itself: This is important when creating multi-layered substrates, like that used in more complex devices (e.g. Microelectromechanical Systems (MEMs)/Biological MEMs/semiconductor packaging, etc.). The photoactive glass of the present invention provides a more consistent thermal bond at a lower temperature, for example 480C for 4 hours, compared to commercially available photoactive glass which, in our experience, requires 550C for 8 hours.

It is a still further object of this invention to provide a solid glass-ceramic substrate which will contain additional surface functional groups such as carboxylates, esters, alcohols, carbamides, aldehydes, amines, sulfur oxides, nitrogen oxides, or halides, which may facilitate attachment of analytical reactants and/or particles, and/or solid substrates to bond to the solid glass ceramic support. These attachments can be obtained by silane chemistry. Silane chemistry is a well known field that has applications as adhesion promotors, crosslinking agents, water scavengers, and coupling agents. Silane chemistry is used to improve the adhesion and sealants to glass-ceramic materials. Silane sealants are designed to fill and prevent water and air passage as well as promote chemical resistant through the areas applied to the glass-ceramic material. This promotes surfaces that improve resistance to heat, ultraviolet radiation, humidity, and water. Therefore, silane chemistry can be used to promote adhesion, crosslinking, water scavenging, and coupling agents on glass-ceramic surfaces. As adhesion promoters, silanes improve moisture, temperature, and chemical resistances. Silanes as crosslinkers, such as acrylates, polyethers, polyurethanes, and polyesters improve tear resistance, elongation at the break and tear propagation. Silanes on glass-ceramics act as water scavengers by reacting rapidly with water, and, therefore, prevent premature cure during compounding, enhance uniform curing, and improve package stability. Silanes as coupling agents on glass-ceramics increase mixing, better bonding of pigment of fillers to resins, and add matrix material. Silanes can also improve the wet and dry tensile, flexural, and compressive strength of glass-ceramics and can be used to improve the compatibility between inorganic particles, organic resins, plastic materials, rubber, and plastic matrixes.

Silanes are monomeric silicon compounds with four substituents groups attached to a silicon atom. The substituent groups can be comprised of almost any combination of nonreactive, inorganically reactive, or organically reactive groups. The basic or fundamental structure of silanes is RnSi(OR)4-n with organosilanes with “R” being an alkyl, aryl, or organofunctional group. Inorganic reactivity is formed from covalent bonds formed through oxygen to the silicon atom forming a siloxane bond. Organic reactivity occurs on the organic molecule which does not directly involve the silicon atom. The large combinations of function groups described above explain silicon's versatility and its ability to be used in a variety of applications with carbon-based chemicals. For example, special characteristics for the silane chemistry can be tailored by adding non-reactive groups such as methyl or larger alkyl groups with phenyl groups. Examples of silane chemistries include but are not limited to organosilanes, aminosilanes, olefin containing silane, vinyl silanes, epoxy silanes, methacryl silanes, sulfur terminated silanes, phenyl silanes, and chlorosilanes. Silicon is a major constituent of glass ceramic materials. Silanes will bond covalently with glass ceramic surfaces fabricated within our patent.

Sulfur terminated silanes example: Mercaptopropyltrimethoxysilane HS(CH₂)₃Si(OMe)₃, Organosilanes, Aminosilanes, 3-aminopropyl triethoxysilane, 3-aminopropylmethyldiethoxysilane, 3-aminopropyl dimethylethoxysilane, 3-aminopropyl trimethoxysilane, N-(2-aminoethyl)-3-aminopropylmethyl dimethoxysilane, N-(2-aminoethyl-3-aminopropyl)trimethoxysilane, aminophenyl trimethoxysilane, 4-aminobutyldimethyl methoxysilane, 4-aminobutyltriethoxysilane, aminoethylaminomethylphenethyl trimethoxysilane and mixtures thereof, Vinyl silanes: Vinyltriethoxysilane, Olefin containing silane: olefin-containing silane is selected from the group consisting of 3-(trimethoxysilyl)propyl methacrylate, N-[3-(trimethoxysilyl)propyl]-N′-(4-vinylbenzyl)ethylenediamine, triethoxyvinylsilane, triethylvinylsilane, vinyltrichlorosilane, vinyltrimethoxysilane, vinyltrimethylsilane, and mixtures thereof, Epoxy silanes: (3-glycidoxypropyl)trimethoxysilane, Methacryl silanes: 3-(trimethoxysilyl)propyl methacrylate, Phenyl silanes: silylbenzene, Chlorosilanes: Dimethyldichlorosilane. The surface is polymerized from olefin-containing monomer is selected from the group consisting of acrylic acid, methacrylic acid, vinylacetic acid, 4-vinylbenzoic acid, itaconic acid, allyl amine, allylethylamine, 4-aminostyrene, 2-aminoethyl methacrylate, acryloyl chloride, methacryloyl chloride, chlorostyrene, dichlorostyrene, 4-hydroxystyrene, hydroxymethylstyrene, vinylbenzyl alcohol, allyl alcohol, 2-hydroxyethyl methacrylate, poly(ethylene glycol)methacrylate, and mixtures thereof.

The solid support is polymerized with a monomer selected from the group consisting of acrylic acid, acrylamide, methacrylic acid, vinylacetic acid, 4-vinylbenzoic acid, itaconic acid, allyl amine, allylethylamine, 4-aminostyrene, 2-aminoethyl methacrylate, acryloyl chloride, methacryloyl chloride, chlorostyrene, dichlorostyrene, 4-hydroxystyrene, hydroxymethyl styrene, vinylbenzyl alcohol, allyl alcohol, 2-hydroxyethyl methacrylate, poly(ethyleneglycol) methacrylate, and mixtures thereof, together with a monomer selected from the group consisting of acrylic acid, methacrylic acid, vinylacetic acid, 4-vinylbenzoic acid, itaconic acid, allyl amine, allylethylamine, 4-aminostyrene, 2-aminoethylmethacrylate, acryloyl chloride, methacryloyl chloride, chlorostyrene, dichlorostyrene, 4-hydroxystyrene, hydroxymethyl styrene, vinylbenzyl alcohol, allyl alcohol, 2-hydroxyethyl methacrylate, poly(ethylene glycol) methacrylate, methyl acrylate, methylmethacrylate, ethyl acrylate, ethyl methacrylate, styrene, 1-vinylimidazole, 2-vinylpyridine, 4-vinylpyridine, divinylbenzene, ethylene glycol dimethacrylate, N,N′-methylenediacrylamide, N,N′-phenylenediacrylamide, 3,5-bis(acryloylamido)benzoic acid, pentaerythritol triacrylate, trimethylolpropane trimethacrylate, pentaerytrithol tetraacrylate, trimethylolpropane ethoxylate (14/3 EO/OH)triacrylate, trimethylolpropane ethoxylate (7/3 EO/OH)triacrylate, trimethylolpropane propoxylate (1 PO/OH)triacrylate, trimethylolpropane propoxylate (2 PO/OH)triacrylate, and mixtures thereof.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

5. The method of claim 1, wherein the one or more metals comprise metals, alloys, metal-nanoparticles, alloy nanoparticles, metal inserts, alloy inserts, noble metals or a combination thereof.

6. The method of claim 1, further comprising the step of coating the one or more metals with a second dielectric coating material.

7. The method of claim 4, wherein the second dielectric coating material is SiO₂, SiN or a combination thereof.

8. The method of claim 1, further comprising the step of coating at least a portion of the device with one or more polymers, one or more metal, one or more alloys, one or more metal-nanoparticles, one or more alloy nanoparticles, one or more metal inserts, one or more alloy inserts, one or more noble metals or a combination thereof.

9. The method of claim 1, wherein the glass substrate is heated to a temperature of 420-520° C. for between 10 minutes and 2 hours and then heated to a temperature range heated to 520-620° C. for between 10 minutes and 2 hours.

10. The method of claim 1, further comprising the step of smoothing the surface using a surface-smoothing acid containing at least one of nitric acid to dissolve surface metals and hydrochloric acid to dissolve surface cerium metal is used during or after the HF etch, whereby surface roughness of at least one micro-optic device in the shaped glass structure is reduced and whereby light transmission through surfaces of a micro-optic device is increased.

11. The method of claim 1, wherein the etched features occur at different elevations on the material.

12. The method of claim 1, further comprising the step of contacting the photosensitive glass substrate with at least a second photosensitive glass substrate to form a larger system.

13. A device made by the method of claim 1.

14. The method of claim 1, wherein one or more metals comprises Cu, Ni, Pt, Pd, Au, Ag, Cr, NiCr, Zn, Ti, W, Sn, PdSn, a conductive polymer or combinations thereof.

15. The method of claim 1, wherein the etchant solution comprises HF.

16. The method of claim 1, further comprising the step of coating at least a portion of the device with metal or alloys, metal-nanoparticles, alloy nanoparticles, metal inserts, alloy inserts, noble metals or a combination thereof or polymers.

17. The method of claim 1, wherein the whole device is converted into a crystalline form after initial feature formation.
